(19) United States
(12) Patent Application Publication
(10) Pub. No.: US 2026/0178819 A1
(43) Pub. Date: Jun. 25, 2026

(54) TOPIC MODELING FRAMEWORK

(71) Applicant: Walmart Apollo, LLC, Bentonville, AR (US)

(72) Inventors: Amit Bendale, Bangalore (IN); Anindya Das, Malda (IN)

(21) Appl. No.: 19/392,453

(22) Filed: Nov. 18, 2025

Related U.S. Application Data
(60) Provisional application No. 63/738,645, filed on Dec. 24, 2024.

(51) Int. Cl. G06F 40/166; G06F 40/30

(52) U.S. Cl. CPC G06F 40/166; G06F 40/30

(57) ABSTRACT

Systems and methods for topic modeling of conversational data are disclosed. In an example, text data is received and is related to one or more topics. Text data is provided to a first machine learning model perform text preparation tasks. A summarization of the text data is generated using a second machine learning model. Clusters of the summarization are determined using a third machine learning model. The one or more topics are identified using a fourth machine learning model. Subtopics of each of the identified one or more topics are identified by recursively using the fourth machine learning mode. An output of the summarization, the identified one or more topics, and the identified one or more subtopics of each of the identified one or more topics is generated. The generated output is displayed to a user and feedback on the output is received.

### CROSS REFERENCE TO RELATED APPLICATION

This application claims benefit to U.S. Provisional Patent Application No. 63/738,645, entitled “TOPIC MODELING FRAMEWORK,” filed on Dec. 24, 2024, the disclosure of which is incorporated herein by reference in its entirety.

### TECHNICAL FIELD

This application relates generally to topic modeling of conversational data, and more particularly, to creating a topic modeling framework for unstructured text data.

### BACKGROUND

An application on a user device such as a smartphone may utilize topic modeling of conversational text applying language processing through multiple machine learning models to label and define unstructured text. Such a user device may utilize topic modeling may be used to classify text, such as free-form conversational text, into related (e.g., grouped) conversations.

### BRIEF DESCRIPTION OF THE DRAWINGS

Various examples will be described below with reference to the following figures.

FIG. 1 depicts an example system for generating a topic framework, in accordance with some embodiments.

FIG. 2 depicts a summarization quality evaluation system, in accordance with some embodiments.

FIG. 3 depicts an example of topic coherence evaluation, in accordance with some embodiments.

FIG. 4 is a flow diagram depicting an example method for generating a topic framework, in accordance with some embodiments.

FIG. 5 depicts an example system for generating a topic framework that includes a machine-readable medium encoded with example instructions executable by a processing resource, in accordance with some embodiments.

FIG. 6 illustrates a block diagram of a computing device, in accordance with some embodiments.

### DETAILED DESCRIPTION

The disclosed systems and methods provide flexible topic modeling that is capable of generating new topics directly from provided free form text. As discussed in greater detail below, in some embodiments, the implementation of a topic modeling process enables a topic framework system to utilize built-in evaluations to automate a topic modeling process, providing a semantic based process. The semantic based topic modeling considers an entire sentence and a context of the text data to generate topics that are interpretable and actionable by additional processes. In addition, in some embodiments, the use of user feedback and/or threshold evaluations, each of which may be used to identify different processes and models that may be reprocessed to return a different topic output, allows for improved summarization of the input and generation of more accurate topics that fully encompass the subject of the input. The disclosed systems and methods use multiple machine learning models and embedding vectors relating to the input text to allow the topics to be easily understandable and applicable to the text. The topics are no longer generic or broad topics generated from reference corpus and are generated from uniquely generated embeddings. Accurately defined topics generated from embeddings ensure the input is properly stored and easily found when searched in a database or generated user interface. These and other advantages will be apparent from the disclosure herein.

Although some current systems can extract elementary conversational topics using limited natural language processing (NLP) capabilities, these systems rely on the predefined topics and cannot improvise new topics from the text. Further, existing systems still require human operator input for classification and typically have processing restrictions which limit the amount of data that can be processed. Although some existing systems can generate topics from combinations of words, these systems are inefficient, utilizing known sets of words (e.g., bag-of-words approaches) that is only capable of handling known combinations. Since conversational data can include text with different grammar and languages, generating topics using these limited processes results in topics that are not interpretable or actionable. However, such processes cannot efficiently operate on large scale datasets, such as those collected by network environments.

In various embodiments, a system for generating a topic framework is disclosed. The system includes a processor and a non-transitory memory storing instructions. The instructions, when executed, cause the processor to receive text data of a message from a device. The text data is related to one or more topics. Text preparation tasks are performed on the text data by a first machine learning model and a summarization of the text data is generated by a second using a second machine learning model. One or more clusters of a set of embedding vectors of the summarization are determined using a third machine learning model. One or more topics based on the one or more clusters are identified by using the fourth machine learning model. One or more subtopics of each of the identified one or more topics are identified by recursively using the fourth machine learning model. The instructions, when executed, further cause the processor to generate an output of the summarization, the identified one or more topics, and the identified one or more subtopics of the identified one or more topics.

In various embodiments, a computer-implemented method for topic modeling is disclosed. The computer-implemented method includes steps of receiving text data from a device. The text data is related to one or more topics. Text preparation tasks are performed on the text data by a first machine learning model and a summarization of the text data is generated by a second using a second machine learning model. One or more clusters of a set of embedding vectors of the summarization are determined using a third machine learning model. One or more topics based on the one or more clusters are identified by using the fourth machine learning model. One or more subtopics of each of the identified one or more topics are identified by recursively using the fourth machine learning model. The method further includes a step of generating an output of the summarization, the identified one or more topics, and the identified one or more subtopics of the identified one or more topics.

In various embodiments, a non-transitory computer-readable medium having instructions stored thereon is disclosed. The instructions, when executed by a processor, cause a device to perform operations including receiving text data. The text data is related to one or more topics. The instructions further cause the device to perform text preparation tasks on the text data by a first machine learning model and a summarize the text data by a second using a second machine learning model. One or more clusters of a set of embedding vectors of the summarization are determined using a third machine learning model. One or more topics based on the one or more clusters are identified by using the fourth machine learning model. One or more subtopics of each of the identified one or more topics are identified by recursively using the fourth machine learning model. The instructions further cause the device to perform operations including generating an output of the summarization, the identified one or more topics, and the identified one or more subtopics of the identified one or more topics.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for topic modeling of conversational data using built-in evaluation to generate a topic modeling framework for unstructured text data. In various embodiments, text data is received, for example, from a user device. The text data may be related to one or more topics. Text preparation tasks may be performed on the text data and a summarization of the text data may be generated. The preparation tasks may be performed by a first machine learning model and the summarization of the text data may be generated by a second machine learning model. One or more clusters of a set of embedding vectors of the summarization may be determined by a third machine learning model. One or more topics may be identified from the one or more clusters using a third machine learning model. The topics may be identified by a fourth machine learning model. One or more subtopics of each of the identified one or more topics may be identified by recursively using the fourth machine learning model. An output including the summarization, the identified one or more topics, and the identified one or more subtopics may be generated. The generated output is displayed, and feedback may be received. A determination is made whether the feedback meets a predefined threshold and, responsive to determining the feedback meets the predefined threshold, a second output is generated.

In some embodiments, systems and methods for generating a topic framework include the use of one or more trained machine learning models. The one or more machine learning models may include, for example, preprocessing models. The one or more machine learning models may further include, for example, large language models (LLM) such as standalone transformer models like Bert2Bert or DistilBert. In general, parameters of a trained function may be adapted by means of training. A combination of supervised training, semi-supervised training, unsupervised training, reinforcement learning and/or active learning may be used. Furthermore, representation learning (an alternative term is “feature learning”) may be used. The parameters of the trained functions may be adapted iteratively by several steps of training.

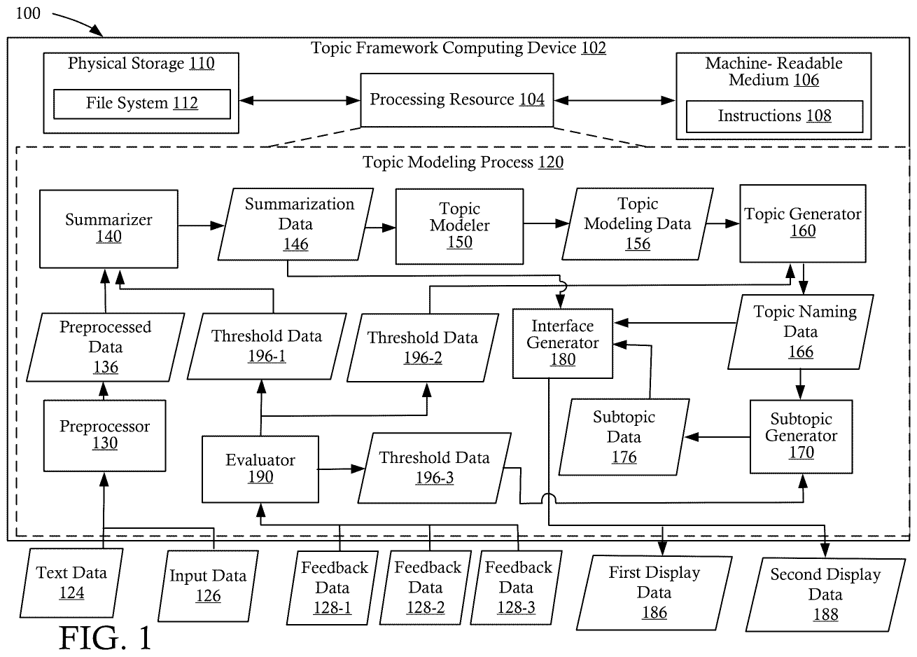

FIG. 1 depicts an example system 100 for generating a topic framework, in accordance with some embodiments. The system 100 includes a topic framework computing device 102 that generates a summarization of text data (e.g., conversational text), identifies one or more topics and one or more subtopics in the text data, and subsequently utilizes the summarization, one or more topics, and one or more subtopics to generate a topic modeling framework for unstructured text data. The topic framework computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The topic framework computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine-readable medium 106 to perform functions of the topic framework computing device 102, such as receiving text data, generating summarization data, topic data, and subtopic data, and generating a topic modeling framework for the received unstructured text. The instructions 108 may include instructions for implementing one or more models. In some embodiments, and as will be described further herein below, the topic framework computing device 102 may execute one or more models, processes, or algorithms.

The topic framework computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the topic framework computing device 102. In some implementations, physical storage 110 may be accessed as a block storage device.

In some cases, the topic framework computing device 102 may also include a local file system 112 that may be implemented as a layer on top of the physical storage 110. For example, an operating system may be executing on the topic framework computing device 102 (by virtue of the processing resource 104 executing certain instructions 108 related to the operating system) and the operating system may provide a file system 112 to store data on the physical storage 110.

The topic framework computing device 102 may be in communication with a plurality of devices or systems over one or more network channels. For example, in various embodiments, the topic framework computing device 102 may be in communication with one or more a cloud-based engines or servers such as one or more processing devices that may be provisioned for use (e.g., a web server, a processing server, etc.), a database, a workstation, and/or any other suitable system or device.

In some embodiments, the topic framework computing device 102 implements one or more processes, such as topic modeling process 120. A text preprocessor 130 may receive text data 124 and input data 126 and generate preprocessed data 136. In some embodiments, the text data 124 may include free-form conversational or unstructured text data. For example, the text data 124 may include, but is not limited to, customer-agent chats, call transcripts, and/or other interaction records. The text data 124 may include, but is not limited to, free flowing text in different languages (e.g., English, French, Spanish). In some embodiments, the text data 124 is text data of a message received from a device. In some embodiments the text data 123 is processed to remove personally identifying information or text related to sensitive topics. The text data 124 may include multiple instances that can be received and processed. In some embodiments, and as described herein, the topic framework computing device 102 may associate the text data 124 with one or more topics identified based on the received text data.

In some embodiments, the input data 126 includes basic configurations. For example, the basic configurations may include, but are not limited to, a language selection, a quantity of topics desired, a quantity of subtopics desired, etc. The input data 126 may include parameters to assist the topic framework computing device 102 in generating an output.

In some embodiments, the preprocessed data 136 includes a simplification of text data 124. In some embodiments, preprocessed data 136 is generated by a first machine learning model, which may be implemented at or as part of preprocessor 130. For example, a first machine learning model for generating preprocessed data 136 may include a natural language processing (NLP) preprocessing model. In some embodiments, the first machine learning model may perform preprocessing tasks (which may also referred to as text preparation tasks) on the conversational text of the text data 124. The preprocessing tasks may include, but are not limited to, removal of HTML tags, identifiers, lowercasing each letter of the text, normalization, etc.

In some embodiments, a summarizer 140 receives the preprocessed data 136 and generates summarization data 146. The summarization data 146 may be a summarization of conversational text represented by text data 124, for example as formatted in the preprocessed data 136, and may include a semantic-based summarization of the conversation text. A semantic-based summarization may consider not only letters and words, but whole sentences, grammar, context, and/or language in generating summaries. In some embodiments, the summarization data 146 may be generated by a second machine learning model, such as an LLM including a standalone transformer model (e.g., Bidirectional Encoder Representation for Transformers (BERT) based model such as bert2bert), which may be implemented at or as part of summarizer 140. The output of the second machine learning model may include a vector representation of sentences, paragraphs, and images of the summarization data 146 (e.g., text embedding vectors) that embeds the text data 124 in vector space such that similar text is physically close and may be efficiently found using a similarity, such as a cosine similarity. In some embodiments, the use of a standalone transformer model eliminates data noise and focuses topic modeling on the substance of the text data 124. The second machine learning model may be language specific or language agnostic.

In some embodiments, topic modeler 150 receive the summarization data 146 and outputs topic modeling data 156. For example, responsive to feedback data 128 indicating positive feedback for a summarization, the summarization data 146 may be provided from the summarizer 140 to the topic modeler 150. In some embodiments, the topic modeler 150 implements a third machine learning model that receives the summarization data 146 and outputs the topic modeling data 156. For example, the third machine learning model may receive text embedding vectors of the summarization data 146 generated from the second machine learning model, e.g., a standalone transformer model, and cluster the text embedding vectors. In some embodiments, the third machine learning model includes a topic model (e.g., BERTopic).

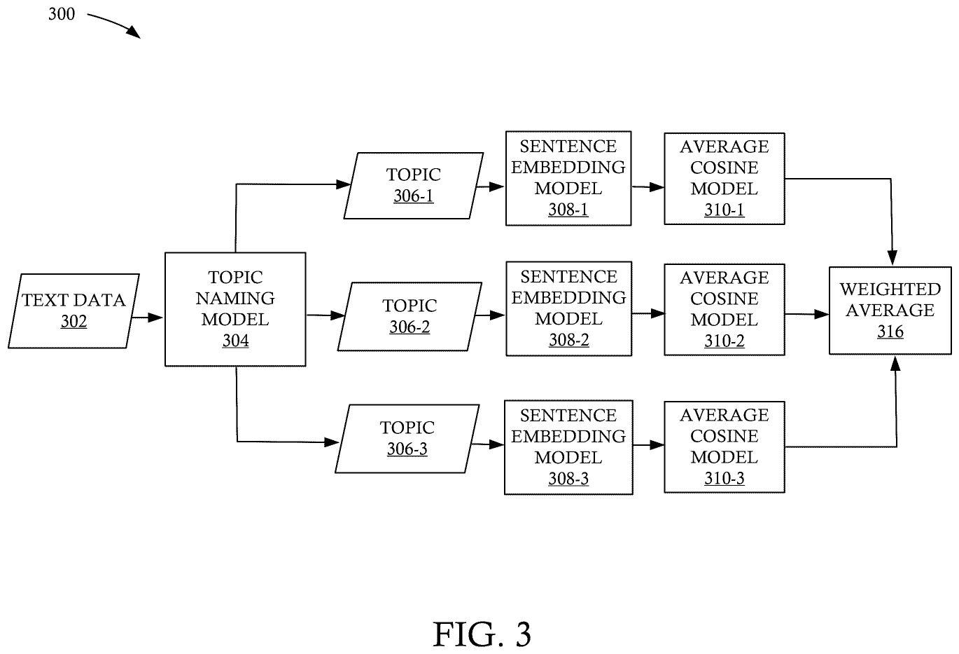

In some embodiments, a topic generator 160 receives the topic modeling data 156 and generates topic naming data 166 including one or more topics. The topics are generated from clusters of text embedding vectors. In some examples, the one or more topics may include single terms or phrases. In some embodiments, the topics may be identical to terms found in the text data 124, terms that are related to the terms in the text data 124 but are not identical, terms that are semantically similar to the text in the text data 124 or semantically similar to the summarization data 146, keyword based, and/or otherwise generated from text data 124. In some embodiments, topic generator 160 implements a fourth machine learning model that receives the topic modeling data 156 as an input and generates topics for the text data 124. The fourth machine learning model may identify clusters from text embedding vectors and generate topics. The application of the fourth machine learning model may provide interpretability, providing topics that are easily understandable. In some embodiments, the topics may be considered large (e.g., broad) topics that encompass a variety of different input text and may include one or more sub-topics. For example, the large topic may include “order” and sub-topics may include “order delivery and cancellation issues,” “order placement and delivery issues,” etc. The generation of the subtopics is described in further detail below. It may be beneficial to control the number of topics for tracking convenience. In some embodiments, an optimal quantity of topics may be chosen through metric optimization, such as coherence (discussed in further detail with respect to FIG. 3). In some embodiments, a quantity of topics determined from the clusters may be limited by input data 126, e.g., a basic configuration identifying a maximum quantity of topics, and/or threshold data 196. In some embodiments, the fourth machine learning model includes an LLM, such as a generative pretraining transformer model (GPT). In some embodiments, generated topic names may be manually revised.

In some embodiments, a subtopic generator 170 receives topic naming data 166 and generates subtopic data 176. In some embodiments, subtopic data 176 includes one or more subtopics for at least one of the topics in the topic naming data 166. For example, the one or more subtopics may be generated by recursively applying the fourth machine learning model to the one or more identified topics. It may be beneficial to control the number of subtopics for tracking convenience. In some embodiments, the optimal quantity of subtopics may be chosen through metric optimization, such as coherence (discussed in further detail below with respect to FIG. 3). In some embodiments, the quantity of subtopics determined by recursively applying the fourth machine learning model may be limited by input data 126, e.g., a basic configuration identifying a maximum quantity of topics, and/or threshold data 196. In some embodiments, the generated subtopics may be manually revised for one or more topics.

In some embodiments, the interface generator 180 receives summarization data 146, topic naming data 166, and subtopic data 176, and generates first display data 186. The interface generator 180 transmits the first display data 186 to a user device for inclusion in a user interface. In some embodiments the first display data 186 includes, but is not limited to, the summarization of the conversational text of the text data 124, the one or more identified topics, the one or more identified subtopics, a quantity of topics identified, a percentage of topic coverage for the multiple instances of received text data 124, and a quantity of received text data 124 for each of the one or more identified topics and each of the one or more identified subtopics.

In some embodiments, the evaluator 190 receives feedback data 128-1 on a rating of the quality of the semantic based summarization of the text data 124. The evaluator 190 determines when the feedback data 128-1 indicates quality of the semantic based summarization is above (or equal to) a predetermined threshold value and generates threshold data 196-1. The threshold data 196-1 may include, for example, an indication of a high-quality summarization (e.g., a quality value above a predetermined threshold) or a low-quality summarization (e.g., a quality value below a predetermined threshold). The threshold data 196-1 may indicate whether the preprocessed data 136 should be reprocessed by the summarizer 140. Responsive to receiving feedback data 128-1 and reprocessing the preprocessed data 136, the summarizer 140 generates updated summarization data 146. In some embodiments, reprocessing may be omitted based on the feedback data 128-1 (e.g., feedback indicating high quality summary) and/or when feedback data 128-1 is not received.

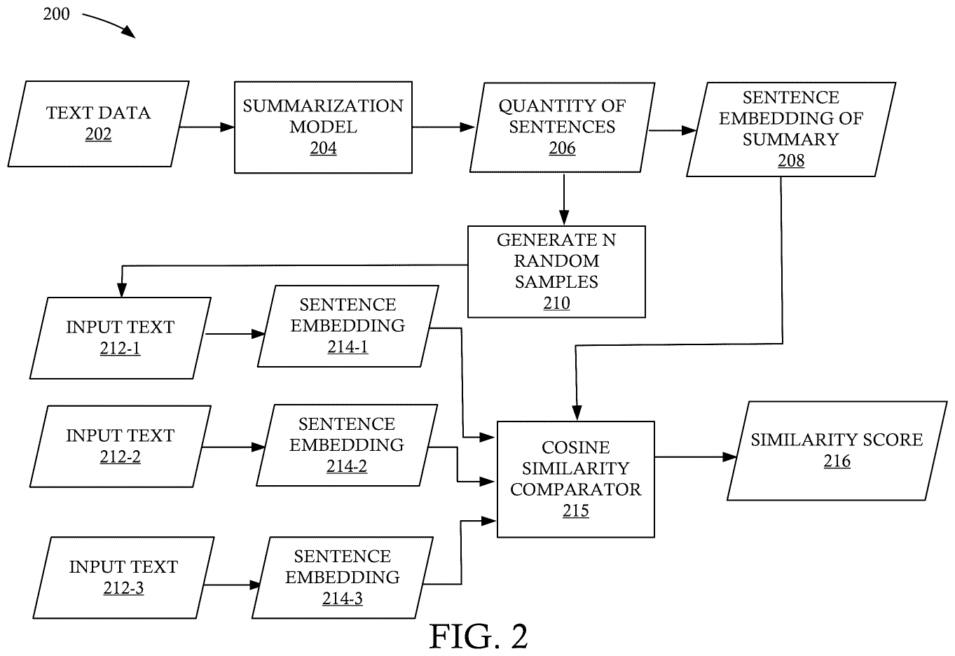

In some embodiments, the feedback data 128-1 may include a heuristic metric characterizing a summarization strength of the conversational text. The heuristic metric includes data derived from rule based algorithms or metrics that categorize the data, such as the output of the summarizer 140. For example, a summary quality evaluation, as further discussed below with respect to FIG. 2, may be generated for the summarization data 146 and the summary may be evaluated to generate feedback data 128-1 including a quality evaluation of the summary. The feedback data 128-1 indicating a poor or unacceptable summarization is transmitted to evaluator 190 and may be included in the threshold data 196-1. Responsive to the threshold data 196-1 comprising feedback data 128-1 indicating a poor or unacceptable summarization, the summarizer 140 may generate a new summary of the conversational text. In some examples, summarizer 140 may modify or adjust one or more model elements based on the threshold data 196-1 before reprocessing the conversational text and generating updated summarization data 146. The updated summarization data 146 may include a different semantically based summarization of the conversational text.

In some embodiments, the evaluator 190 receives feedback data 128-2 on the quality of the names of the one or more topics of topic naming data 166. For example, in some embodiments, if the feedback data 128-2 of the quality of the one or more topics is above (or equal to) a predetermined threshold value, the evaluator 190 generates threshold data 196-2. In some embodiments, the evaluation is the interpretability quality of the summarization data 146. The evaluation can be an indication of a high-quality topic name or a low quality topic name. In some embodiments, the user feedback 128-2 may include data heuristic metrics indicating a desired change of a characteristic for at least one topic. For example, in some embodiments, a topic adherence evaluation, as further discussed below with respect to FIG. 3, is generated for one or more topics. In some embodiments, the feedback data 128-2 includes an indication that one or more topics are to be split, merged, and/or renamed. Responsive to a determination that the feedback data 128-2 indicates a desired change of a characteristic of one or more topics, the topic generator 160 may reprocess the received topic modeling data 156 (or other received data) by applying the fourth machine learning model and generating reprocessed topic naming data 166.

In some embodiments, the evaluator 190 receives feedback data 128-3 on the quality of the one or more subtopics of subtopic data 176. For example, in some embodiments, if the feedback data 128-3 of the quality of the one or more subtopics is above (or equal to) a predetermined threshold value, the evaluator 190 generates threshold data 196-3. In some embodiments, the user feedback 128-3 may include data heuristic metrics indicating a desired change of a characteristic for at least one topic. In some embodiments, the feedback data 128-3 includes an indication that one or more topics are to be split, merged, and/or renamed. Responsive to a determination that the feedback data 128-3 indicates a desired change of a characteristic of one or more topics, the subtopic generator 170 may reprocess the received topic naming data 166 (or other received data) by reiteratively applying the fourth machine learning model and generating reprocessed subtopic data 176.

In some embodiments, the evaluator 190 determines that the feedback data 128 satisfies a predetermined threshold, and the interface generator 180 generates the second display data 188. In some embodiments, the second display data 188 includes one or more modifications to the first display data 186 caused by one or any combination of user feedback 128-1, 128-2, and 128-3 for the first display data 154. Responsive to a determination that the threshold does not satisfy a predetermined threshold, the interface generator 180 continues to display the first display data 186.

FIG. 2 depicts an example of a summarization quality evaluation system 200, in accordance with some embodiments. Text data 202 is received by a summarization model 204. As discussed above, the summarization model 204 may include an LLM, such as a bert2bert standalone transformer model. The output of the summarization model 204 may be assigned a value N representing a quantity of sentences 206 in the text data 202. The value N can change for each instance of text data 202. A sentence embedding summary model 208 generates an embedding vector for each of N sentences in the text data 202. In some embodiments, the sentence embedding summary model 208 receives a pre-generated summary of the text data and creates embedded vectors based on the pre-generated summary. The value of the N quantity of sentences 206 may be used to generate N random samples 210, which may be applied to the input text 212-1 to 212-3 (collectively “input text 212”). The input text 212 may include random samples from the text data 202. The input text 212 may be input into a corresponding sentence embedding model 214-1 to 214-3 (collectively “sentence embedding models 214”). In some embodiments, a similarity vector embedding is generated from the corresponding sentence embedding models 214 and vector embeddings generated from the sentence embedding summary model 208 are determined. The similarity may be determined by a cosine similarity comparator 215, which may impose one or more limits on a similarity score 216 (e.g., the bounds of the similarity score may be −1 to 1). A high similarity score (e.g., a similarity score closer to 1) indicates that a summarization of the text data 202 generated by the first machine learning model is an accurate summarization. The summarization quality evaluation may implement one or more metrics to evaluate the success of the summarization, such as recall-oriented understudy for gisting evaluation (ROUGE), bilingual evaluation understudy (BLEU), BERTscore, and/or metric for evaluation of translation with explicit ordering (METER). Once the summarization has been determined and evaluated by one or more metrics, the similarity score 216 and the summary may be transmitted for display on a user interface.

FIG. 3 depicts an example of topic coherence evaluation system 300, in accordance with some embodiments. Text data 302 may be provided to a topic naming model 304. In some embodiments, the topic naming model 304 receives summarization data, such as summarization data 146, as an input and generates a set of topic names from the summary. In some embodiments, the topic naming model 304 includes an LLM, such as a GPT model. The output of the topic naming model 304 includes topics 306-1 to 306-3 (collectively “topics 306”). Each of the topics 306 may be provided to a respective sentence embedding model 308-1 to 308-3 (collectively “sentence embedding models 308”), each of which generates vector embeddings representative of the corresponding received one of the topics 306. The output of each of the sentence embedding models 308 is provided to a respective comparison model 310-1 to 310-3 (collectively “average comparison models 310”). The average comparison models 310 each generate a similarity value, such as a cosine similarity, between the vector embeddings representative of each of the topics 306. The similarity may be generated as a dot product of the vectors divided by a product of their lengths. The output values of each of the average comparison models 310 may be provided to a weighted average model 316 that generates an output coherence score. The coherence score may be within a predetermined range, such as a range of −1 to 1, and represents the coherence between the generated topics 306. The higher the value of the coherence score, the better coherence there is between the generated topics 306. The coherence score may be provided for use in one or more additional processes, such as topic evaluation and/or display on a user interface.

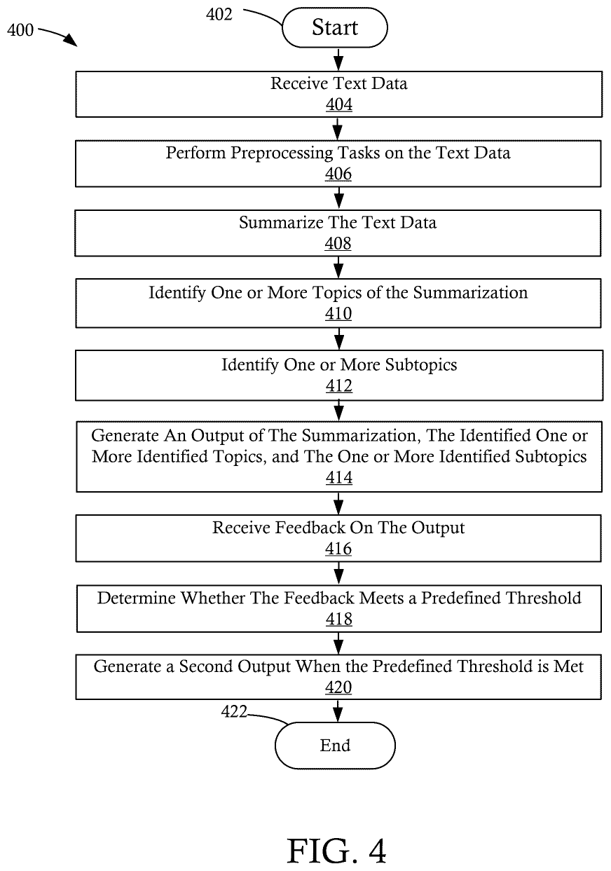

FIG. 4 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 4 may be implemented in the form of executable instructions stored on a machine-readable media and executed by a processing resource and/or in the form of electronic circuitry. For example, aspects of the method may be described below as being performed by a topic modeling system, an example of which may be the topic modeling process 120 running on a hardware processing resource 104 of the topic framework computing device 102 described above. Additionally, other aspects of the method described below may be described with reference to other elements shown in FIG. 1 for non-limiting illustration purposes.

FIG. 4 is a flow diagram depicting an example method 400 for topic framework generation, in accordance with some embodiments. Method 400 starts at block 402 and continues to block 404, where text data is received. Text data may include conversational, e.g., free-form, text data. For example, the text data may include, but is not limited to, customer-agent chats and/or call transcripts. The text data may include text in one or more languages (e.g., English, French, Spanish). In some embodiments, text data may be generated through one or more user interactions with one or more user interfaces, such as user interactions with a chatbot on a user interface.

At block 406, preprocessing tasks are performed on the text data. Preprocessing data may provide a simplification of the conversational text of the text data. The preprocessing tasks (e.g., removal of HTML tags, identifiers, lowercasing each letter of the text, removal of non-standard characters) may be performed on the text data by a preprocessing model, such as an NLP preprocessing model. Applying preprocessing tasks to the text data may prepare the text data for further processing. In addition to the preprocessing tasks, basic configurations may provide parameters for an expected output. For example, basic configurations may include, but are not limited to, a selection of a language, a number of topics needed, and a number of subtopics needed.

At block 408, the text data is summarized. The text data may be summarized by a text summarization model, such as an LLM model. In some embodiments, the summarization may be semantic based, such as based on vector embeddings generated from the text data. The vector embeddings may allow a summarization model to understand meaning and relationships between words within a context of the text data. The text summarization model may generate a vector embedding representative of not only letters and words, but whole sentences, grammar, and language of the text data. In some embodiments, summarizing text data by applying a summarization model using semantic vector embedding eliminates data noise and provides topic generation based on substance of the text data, allowing successful summarization of large amounts of information. In some embodiments, a summarization of the text data or a summarization quality evaluation may be reviewed, and feedback data may be received. When the feedback data contains an indication that the summary should be regenerated, the text data may be provided to the summarization model via a feedback loop to generate additional and/or alternative vector embeddings and create a new summarization based on the received feedback and, optionally, the initial summarization.

At block 410, one or more topics are generated for the summarized text. The one or more topics may be generated by a topic generator. Sentence embeddings (e.g., multilingual embedding vectors) of the summarization data may be generated and clustered to identify topic names. The generated topic names may be renamed to generate easily understandable topic names. For example, an LLM, such as a GPT model, may be used to rename topics to provide easily understandable outputs.

At block 412 one or more subtopics for each of the one or more topics are identified. In some embodiments, the one or more subtopics may be generated using the same machine learning model implemented at block 410, e.g., the same GPT model, to identify subtopics within each of the one or more topics. The machine learning model may be applied recursively to reduce the granularity of any one subtopic (e.g., consisting of less than 20% of the overall data) to ensure that all possible key subtopics may be identified for each topic. The granularity may be selected to ensure that topics and corresponding subtopics accurately reflect the subject matter of the text data.

At block 414, the summarized text, the one or more topics, and the one or more subtopics may be displayed via a user interface. The output may include first display data. In some embodiments the first display data includes, but is not limited to, the summarization of the message, the one or more identified topics, the one or more identified topics, a number representing the quantity of topics identified, a percentage of topic coverage for all received text data, and a number indicating the quantity of received text data for each of the one or more identified topics and each of the one or more identified subtopics.

In some embodiments, the output is displayed on an interactive user interface. Text data may be stored under a graphical element which corresponds to each of the identified one or more topics. Within the graphical element representing the one or more topics, the corresponding one or more subtopics may be accessible. When both a topic and a subtopic are selected, the text data corresponding to the selected topic and subtopic may be displayed for interaction (e.g., review). In some embodiments, the output includes analytics, such as visualizations of the topic distribution of the text data. By organizing and storing the text data corresponding to topics and subtopics, relevant text data related to a particular topic may be found more efficiently and quickly.

At block 416, feedback on the generated output of block 414 is received. In some embodiments, the feedback may include a name change of one or more topics or subtopics. For example, feedback data may be received via the user interface. In some embodiments, the feedback can indicate a good or bad summarization, topic, or subtopic name.

At block 418, a determination is made whether the feedback received at block 416 meets a predefined threshold. In some embodiments, the determination is a binary determination whether the feedback requests a change. In some embodiments, the determination is a binary determination whether the feedback indicates a good or bad summarization, topic, or subtopic name. Upon determination that the predetermined threshold is met, the feedback data is included in the threshold data.

At block 420, a second output is generated responsive to the determination that the predetermined threshold is met in block 418. In some embodiments, this includes an updated display name of the one or more topics and subtopics. In some embodiments, the second output meets the criteria of the basic user inputs of block 408. In some embodiments, the second output is used to generate a user interface. In some embodiments, the generated user interface can appear as an interactive list of the one or more topics. Each of the one or more topics includes a click-down menu, where the respective one or more subtopics are readily available for user interaction. In each of the one or more topics and respective one or more subtopics, the text data 124 corresponding to the topics and subtopics is stored and ready to be viewed and used by the user. Method 400 ends at block 422.

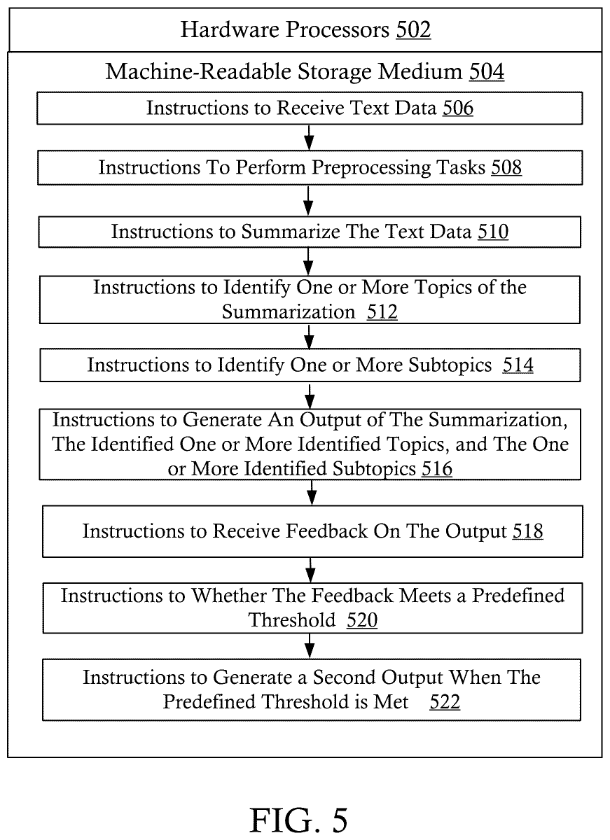

FIG. 5 depicts example system 500 for topic modeling that include a machine-readable media 504 encoded with example instructions executable by processing resource 502. In some implementations the system 500 may be useful for implementing aspects of the topic modeling system 100 of FIG. 1 or performing the aspects of method 400 of FIG. 4. For example, the instructions encoded on machine-readable media 504 may be included in instructions 108 of FIG. 1. In some implementations, functionality described with respect to FIG. 1 may be included in the instructions encoded on machine-readable media 504.

The processing resource 502 may include a microcontroller, a microprocessor, central processing unit core(s), an ASIC, an FPGA, and/or other hardware device suitable for retrieval and/or execution of instructions from the machine-readable media 504 to perform functions related to various examples. Additionally, or alternatively, the processing resource 502 may include or be coupled to electronic circuitry or dedicated logic for performing some or all of the functionality of the instructions described herein.

The machine-readable media 504 may be any medium suitable for storing executable instructions, such as RAM, ROM, EEPROM, flash memory, a hard disk drive, an optical disc, or the like. In some example implementations, the machine-readable media 504 may be a tangible, non-transitory medium. The machine-readable media 504 may be disposed within the system 500 in which case the executable instructions may be deemed installed or embedded on the system. Alternatively, the machine-readable media 504 may be a portable (e.g., external) storage medium, and may be part of an installation package.

As described further herein below, the machine-readable media 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 4.

The machine-readable media 504 includes instructions 506-522. Instructions 506, when executed, cause the processing resource 502 to receive text data. Instructions 508, when executed cause the processing resource 502 to perform text preparation tasks. Instructions 510, when executed, cause the processing resource 502 to summarize the text data. Instructions 512, when executed, cause the processing resource 502 to identify one or more topics in the summarization. Instructions 514, when executed cause, the processing resource 502 to identify one or more subtopics. Instructions 516, when executed cause, the processing resource 502 to generate an output of the summarization, the identified one or more identified topics, and the one or more identified subtopics. Instructions 518, when executed cause, the processing resource 502 to receive feedback on the output from the user. Instructions 520, when executed cause, the processing resource 502 to determine whether the feedback meets a predefined threshold. Instructions 522, when executed cause, the processing resource 502 to generate a second output when the predefined output is met.

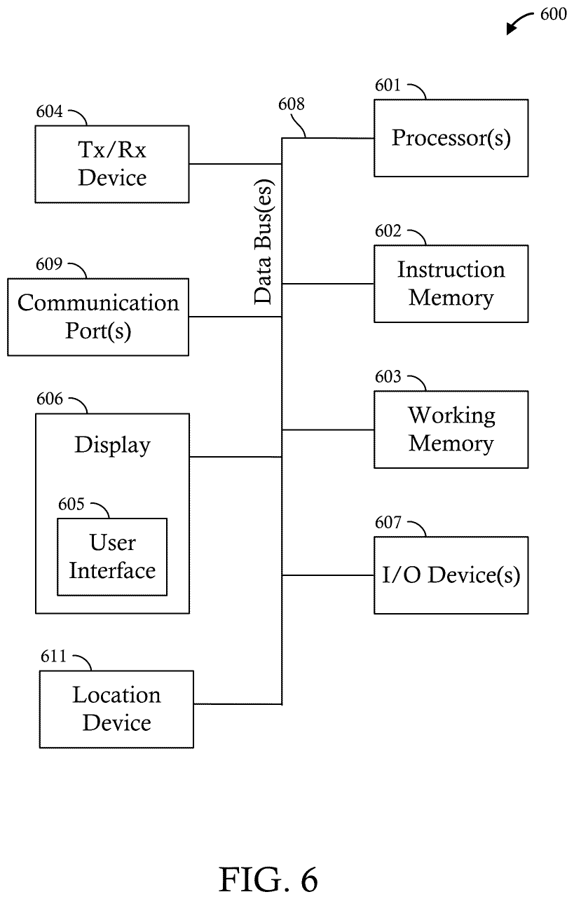

FIG. 6 illustrates a block diagram of a computing device 600, in accordance with some embodiments. Although FIG. 6 is described with respect to certain components shown therein, it will be appreciated that the elements of the computing device 600 may be combined, omitted, and/or replicated. In addition, it will be appreciated that additional elements other than those illustrated in FIG. 6 may be added to the computing device.

As shown in FIG. 6, the computing device 600 may include one or more processing resources 502, instruction memory 604, working memory 606, input/output devices 608, transceiver 610, communication ports 612, display 614, and/or any other suitable elements each operatively coupled to one or more data buses 620. The data buses 620 allow for communication among the various components. The data buses 620 may include wired, or wireless, communication channels.

The one or more processing resources 602 may include any processing circuitry operable to control operations of the computing device 600. In some embodiments, the one or more processing resources 602 include one or more distinct processors, each having one or more cores (e.g., processing circuits). Each of the distinct processors may have the same or different structure. The one or more processing resources 602 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 602 may also be implemented by a controller, a microcontroller, an application specific integrated circuit (ASIC), a field programmable gate array (FPGA), a programmable logic device (PLD), etc.

In some embodiments, the one or more processing resources 602 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 604 may store instructions that are accessed (e.g., read) and executed by at least one of the one or more processing resources 602. For example, the instruction memory 604 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 602 may perform a certain function or operation by executing code, stored on the instruction memory 604, embodying the function or operation. For example, the one or more processing resources 602 may execute code stored in the instruction memory 604 to perform one or more of any function, method, or operation disclosed herein.

Additionally, the one or more processing resources 602 may store data to, and read data from, the working memory 606. For example, the one or more processing resources 502 may store a working set of instructions to the working memory 606, such as instructions loaded from the instruction memory 604. The one or more processing resources 602 may also use the working memory 606 to store dynamic data created during one or more operations. The working memory 606 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 604 and working memory 606, it will be appreciated that the computing device 600 may include a single memory unit that operates as both instruction memory and working memory. Further, although embodiments are discussed herein including non-volatile memory, it will be appreciated that computing device 600 may include volatile memory components in addition to at least one non-volatile memory component.

In some embodiments, the instruction memory 604 and/or the working memory 606 includes an instruction set, in the form of a file for executing various methods, such as methods for image annotation through implementation of localized embeddings, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 602.

The input/output devices 608 may include any suitable device that allows for data input or output. For example, the input/output devices 608 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 610 and/or the communication port(s) 612 allow for communication with a network. For example, if a communication network is a cellular network, the transceiver 610 allows communications with the cellular network. In some embodiments, the transceiver 610 is selected based on the type of the communication network the computing device 600 will be operating in. The one or more processing resources 602 are operable to receive data from, or send data to, a network via the transceiver 610.

The communication port(s) 612 may include any suitable hardware, software, and/or combination of hardware and software that is capable of coupling the computing device 600 to one or more networks and/or additional devices. The communication port(s) 612 may be arranged to operate with any suitable technique for controlling information signals using a desired set of communications protocols, services, or operating procedures. The communication port(s) 612 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 612 allows for the programming of executable instructions in the instruction memory 604. In some embodiments, the communication port(s) 612 allow for the transfer (e.g., uploading or downloading) of data, such as machine learning model training data.

In some embodiments, the communication port(s) 612 couples the computing device 600 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 610 and/or the communication port(s) 612 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 614 may be any suitable display, and may display the user interface 616. The user interfaces 616 may enable user interaction with the annotated reference data and positional encodings identifying the location of each object of the plurality of objects of the reference image. For example, the user interface 616 may be a user interface for an application of a network environment operator that allows a user to view and interact with the operator's website. In some embodiments, a user may interact with the user interface 616 by engaging the input/output devices 608. In some embodiments, the display 614 may be a touchscreen, where the user interface 616 is displayed on the touchscreen.

The display 614 may include a screen such as, for example, a Liquid Crystal Display (LCD) screen, a light-emitting diode (LED) screen, an organic LED (OLED) screen, a movable display, a projection, etc. In some embodiments, the display 614 may include a coder/decoder, also known as Codecs, to convert digital media data into analog signals. For example, the visual peripheral output device may include video Codecs, audio Codecs, or any other suitable type of Codec.

In some embodiments, the computing device 600 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 600 may be a computer, a workstation, a laptop, a server such as a cloud-based server, or any other suitable device. In some embodiments, the computing device 600 is a server that includes one or more processing units, such as one or more graphical processing units (GPUs), one or more central processing units (CPUs), and/or one or more processing cores. The computing device 600 may, in some embodiments, execute one or more virtual machines. In some embodiments, processing resources (e.g., capabilities) of the computing device 600 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that image annotation, labeling, and classification as disclosed herein, particularly on large datasets intended to be used with the disclosed embodiments are only possible with the aid of computer-assisted machine-learning algorithms and techniques, such as a vector encoding models. Trained models may be used to perform operations that cannot practically be performed by a human, either mentally or with assistance, such as image annotation with the use of localized embeddings. It will be appreciated that a variety of machine learning techniques can be used alone or in combination to generate one or more machine learning models to generate positional encodings, feature embeddings, and object-specific cluster centroids.

Although the subject matter has been described in terms of example embodiments, it is not limited thereto. Rather, the appended claims should be construed broadly, to include other variants and embodiments that may be made by those skilled in the art.

What is claimed is:

1. A system comprising:
a processor; and
a non-transitory memory storing instructions that, when executed, cause the processor to:
receive text data from a device, wherein the text data is related to one or more topics;
provide the text data to a first machine learning model to generate preprocessed data, wherein the first machine learning model performs text preparation tasks on the text data;
generate a summarization of the preprocessed data using a second machine learning model;
determine one or more clusters of a set of embedding vectors of the summarization using a third machine learning model;
identify one or more topics based on the one or more clusters using a fourth machine learning model;
identify one or more subtopics of each of the one or more topics by recursively using the fourth machine learning model;
generate an output of the summarization, the one or more topics including a renamed topic, and the one or more subtopics of each of the one or more topics;
display the generated output to a user;
receive feedback on the output from the user;
determine whether the feedback meets a predefined threshold; and
generate a second output when the predefined threshold is met.

2. The system of claim 1, wherein the summarization of the preprocessed data using the second machine learning model is based on semantic vector embeddings generated from the text data.

3. The system of claim 1, wherein the predefined threshold determines whether the preprocessed data is reprocessed by the second machine learning model to generate a new summarization.

4. The system of claim 1, wherein the feedback received from the user is provided to the second machine learning model via a feedback loop to generate additional vector embeddings for generating a new summarization based on the received feedback.

5. The system of claim 1, wherein the feedback received from the user includes an indication that a characteristic of the one or more identified topics is to be changed.

6. The system of claim 5, wherein the characteristic of the one or more identified topics is changed by one or more of: splitting, merging, or renaming.

7. The system of claim 1, wherein generating the summarization of the preprocessed data includes determining a first quantity of sentences in the preprocessed data, and the instructions further comprise instructions that, when executed, cause the processor to generate random samples of the first quantity for use as input text.

8. A computer-implemented method, comprising:
receiving text data from a device, wherein the text data is related to one or more topics;
providing the text data to a first machine learning model to generate preprocessed data, wherein the first machine learning model performs text preparation tasks on the text data;
generating a summarization of the preprocessed data using a second machine learning model;
determining one or more clusters of a set of embedding vectors of the summarization using a third machine learning model;
identifying one or more topics based on the one or more clusters using a fourth machine learning model;
identifying one or more subtopics of each of the one or more topics by recursively using the fourth machine learning model;
generating a first output of the summarization, the one or more topics including a renamed topic, and the one or more subtopics of the one or more topics;
displaying the generated first output to a user;
receiving feedback on the first output from the user;
determining whether the feedback meets a predefined threshold; and
generating a second output when the predefined threshold is met.

9. The method of claim 8, wherein generating the summarization of the preprocessed data is based on semantic vector embeddings generated from the text data.

10. The method of claim 8, wherein the predefined threshold determines whether the preprocessed data is reprocessed by the second machine learning model to generate a new summarization.

11. The method of claim 8, further comprising providing the feedback received from the user to the second machine learning model via a feedback loop to generate additional vector embeddings for generating a new summarization based on the received feedback.

12. The method of claim 8, wherein the feedback received from the user includes an indication that a characteristic of the one or more identified topics is to be changed.

13. The method of claim 12, wherein the characteristic of the one or more identified topics is changed by one or more of: splitting, merging, or renaming.

14. The method of claim 8, wherein generating the summarization of the preprocessed data includes determining a first quantity of sentences in the preprocessed data, and the method further comprises generating random samples of the first quantity for use as input text.

15. A non-transitory computer-readable medium having instructions stored thereon, wherein the instructions, when executed by at least one processor, cause at least one device to perform operations comprising:
receiving text data from a device, wherein the text data is related to one or more topics;
providing the text data to a first machine learning model to generate preprocessed data, wherein the first machine learning model performs text preparation tasks on the text data;
generating a summarization of the preprocessed data using a second machine learning model;
determining one or more clusters of a set of embedding vectors of the summarization using a third machine learning model;
identifying one or more topics based on the one or more clusters using a fourth machine learning model;
identifying one or more subtopics of each of the one or more topics by recursively using the fourth machine learning model;
generating an output of the summarization, the one or more topics including a renamed topic, and the one or more subtopics of the one or more topics;
displaying the generated output to a user;
receiving feedback on the output from the user;
determining whether the feedback meets a predefined threshold; and
generating a second output when the predefined threshold is met.

16. The non-transitory computer-readable medium of claim 15, wherein the summarization of the preprocessed data using the second machine learning model is based on semantic vector embeddings generated from the text data.

17. The non-transitory computer-readable medium of claim 15, wherein the predefined threshold determines whether the preprocessed data is reprocessed by the second machine learning model to generate a new summarization.

18. The non-transitory computer-readable medium of claim 15, wherein the feedback received from the user is provided to the second machine learning model via a feedback loop to generate additional vector embeddings for generating a new summarization based on the received feedback.

19. The non-transitory computer-readable medium of claim 15, wherein the feedback received from the user includes an indication that a characteristic of the one or more identified topics is to be changed.

20. The non-transitory computer-readable medium of claim 19, wherein the characteristic of the one or more identified topics is changed by one or more of: splitting, merging, or renaming.
